(19) United States
(12) Patent Application Publication
(10) Pub. No.: US 2004/0169376 A1
(43) Pub. Date: Sep. 2, 2004

(54) Offshore wind turbine and method for making same

(76) Inventors: Jacques Ruer, Le Pecq (FR); Edmond Coche, Paris (FR); Jean-Paul Gregoire, Paris (FR); Christophe Portenseigne, Beynes (FR); Xavier Rocher, Chatou (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/482,510

(22) PCT Filed: Jul. 5, 2002
(86) PCT No.: PCT/FR02/02361

(30) Foreign Application Priority Data
Jul. 6, 2001 (FR) 01/08977

(51) Int. Cl. F03D 9/00; H02P 9/04

(52) U.S. Cl. 290/55

(57) ABSTRACT

The present invention relates to wind generators installed off-shore, in particular at sea, to support structures forming a part of such wind generators, and to methods of making and installing such wind generators. The technical field of the invention is that of making, transporting, and installing wind generators for producing electricity, more particularly off-shore, and in large numbers, so as to form wind “farms”. The wind generator of the invention comprises a wind turbine and a deployable telescopic pylon or support supporting the turbine, and a gravity base supporting the pylon or support.

The present invention relates to wind generators installed off-shore, in particular at sea, to support structures forming parts of such wind generators, and to methods of manufacturing and installing such wind generators.

The technical field of the invention is that of manufacturing, transporting, and installing wind generators for producing electricity, more particularly very large capacity off-shore wind generators for installing at sea, more particularly away from coasts and in very large numbers, in order to form wind farms.

### BACKGROUND OF THE INVENTION

Whereas land-based wind turbines have been constructed for several centuries, constructing wind generators at sea is much more recent.

A modern wind generator, whether on land or at sea, generally comprises a turbine having a plurality of blades and a horizontal axis, together with an electricity generator coupled to the turbine, both of them being supported at the top end of a vertically elongate support such as a mast or a pylon.

In order to reduce the cost of wind energy and increase generator efficiency, generators are being manufactured of ever-increasing power, and they are installed in groups so as to form a wind “farm”.

Increasing the power of a wind generator has the particular effect of increasing its mass and the height of the structure needed to support it.

The invention applies more particularly, i.e. non-exclusively, to wind generators delivering power in the range 100 kilowatts (kW) to 10 megawatts (MW). The mass of such a generator can reach or exceed 100 metric tonnes (t) or 200 t. The height of a pylon supporting such a generator can be about 50 meters (m) to 100 m, and the mass of the pylon can lie in the range 100 t to 500 t. It will thus be understood that constructing such wind generators presents difficulties.

A wind generator is generally constructed on land using conventional crane-type hoisting means, the pylon being installed on a foundation and the generator subsequently being installed on top of the pylon. Installing large-capacity wind generators on land requires cranes to possess very long jibs, and considerable hoisting capacity. Such cranes are difficult to move and set up, and in particular in order to comply with road clearance regulations they need to be disassembled into a plurality of elements. By way of example, a 350 t crane having a 90 m jib requires nine vehicles, four of which constitute exceptional loads; in addition, setting up the crane takes several days, and taking it down again requires as many.

Installing a wind generator whose base or foundation is immersed in shallow water—less than 10 m of water—presents additional difficulties, particularly when the installation site is several kilometers from the coast line; it is possible under such circumstances to use hoisting equipment of the kind commonly used on land, which is taken to the installation site and placed temporarily on structures themselves resting on the bottom of the water.

Installing a wind generator in deep water presents additional difficulties, even though pontoon cranes presenting considerable load capacity can be used for installation purposes. However, such pontoon cranes need to be capable of operating in the open sea, which considerably reduces the amount of equipment available and generally requires a pontoon crane to be taken from somewhere very distant from the installation site, leading to costs that are unacceptable for project profitability. In addition, such pontoon cranes are generally booked a long time in advance for developing off-shore oil fields, since the critical stages of installation are generally concentrated exclusively in periods of fair weather, i.e. periods when it would also be desirable to be installing off-shore wind generators.

### OBJECTS AND SUMMARY OF THE INVENTION

An object of the invention is to facilitate installing a wind generator on its production site, and in particular a site that is under water.

An object of the invention is to propose a wind generator that is simpler to install at sea.

An object of the invention is to propose a support for a wind turbine and/or generator, a wind generator, a method of transport, and a method of installing wind generators, that are improved and/or that remedy, at least in part, the drawbacks of prior art wind generators and installation methods.

In a first aspect of the invention, the elongate support for securing the wind generator to a base or foundation comprises two portions which, at least until the wind generator is installed on a production site, are mounted to be movable relative to each other, between at least a first position in which said support presents a compact configuration with a first length (or first longest longitudinal dimension), and a second position in which said support presents a deployed configuration and a second length (second longest dimension) which is longer than said first length.

Said support in the compact configuration thus facilitates manufacture, since the maximum height required for hoisting equipment is considerably reduced. It also makes it easier to transport the wind generator between a first site where the main components are assembled, which site may be located, in particular, on land or in shallow water, and a second site where the wind generator is installed in its final configuration, which site may in particular be in water deeper than that of the first site; the invention also makes it easier to erect the wind generator on the second site—where it is to produce energy—, with this being achieved by causing the moving portions of the support to move relative to each other in such a manner as to convert the support from its compact position to its deployed position.

Said deployable support preferably includes means for guiding said moving portions relative to each other, facilitating and guiding their movement from the compact position to the deployed position.

Also preferably, each of said support portions is of elongate shape, said portions being movable in translation by sliding relative to each other so as to obtain a deployable support that is simple to manufacture.

In a more preferred embodiment, said support comprises (and/or consists essentially in) a telescopic pylon, the pylon comprising an elongate bottom portion and an elongate top portion, said bottom and top portions being slidable relative to each other, and one being received at least in part in the other.

Said pylon or support preferably further comprises erector means for erecting the pylon or support so as to cause the support to pass at least part of the way from its compact position to its deployed position by mutual displacement of said portions of the support.

These erector means may comprise means for applying traction which may comprise at least one cable or equivalent deformable elongate link, and means for securing one end of the link to a first one of said support portions, and means for guiding, supporting, and winding said link, such as a pulley or a winch, which means are secured to a second one of said two support portions.

The erector means may also comprise thrust means suitable for contributing to deploying the support, in particular means for applying thrust by hydraulic action.

To this end, in a preferred embodiment, said bottom portion of the pylon or support comprises a first leaktight hollow tubular body closed by a first leaktight transverse wall which is preferably situated close to the bottom end of said bottom portion; and said tubular body is also of shape and dimensions suitable for ensuring that at least a bottom fraction of said top portion of the pylon or support can slide inside said body. Said top portion of the pylon or support comprises a second tubular body, preferably a hollow body and likewise leaktight and closed by a second leaktight wall. Said first tubular body thus defines an elongate cavity that is preferably cylindrical or frustoconical. Said first body is also provided with means for introducing a fluid or a slurry into said cavity receiving said second leaktight tubular body, and it is disposed substantially vertically. Said fluid may be constituted essentially by water taken from the site where the wind generator is being installed. By filling said cavity with said fluid or slurry, said second body is subjected to an upwardly-directed vertical force that results from the buoyancy exerted by the fluid on its walls, thereby contributing to moving it relative to the first body and consequently to deploying the pylon or support. For this purpose, it is advantageous to use a slurry or a fluid of density greater than that of water, such as baryte, cement slip,

Said second tubular body of said upper portion of the pylon or support is preferably hollow, since it advantageously includes an internal stair giving access to the top platform for the generator, together with the major part of the electrical equipment for controlling the wind generator.

Alternatively, or in addition to said passive hydraulic thrust means (buoyancy thrust), said thrust means may comprise means for introducing a driving fluid (or slurry) under pressure into said cavity, together with sealing means for preventing or restricting leakage of said driving fluid passing through the residual annular space that exists between the inside face of the wall of said first body and the outside face of the wall of said second body. This makes it possible to use the first body as the cylinder of an actuator and to use a fraction of said second body as the piston of said actuator. The pressure exerted by said driving fluid present in said cavity against the walls of said second body causes the second body to slide inside the first body and thus enables said pylon or support to be deployed.

The height (or length) of said first tubular body and the diameter (or greatest transverse dimension) of the first body are preferably greater than the height and the diameter respectively of the second body so that in the compact position, said second body can be retracted for the most part inside the first body.

Said pylon or support is preferably made essentially of metal, being obtained by assembling end to end a plurality of cylindrical segments, themselves made by rolling and welding sheet steel.

The invention applies in particular to wind generators having a base or foundation made using aggregate, in particular a hollow base or foundation that is leaktight and compartmentalized, being made at least in part out of concrete.

Under such circumstances, the bottom portion of the pylon or support is anchored in the foundation so as to obtain a connection by the bottom portion being embedded in the foundation.

In another aspect, the invention provides a method of constructing a wind generator comprising a wind turbine and a generator proper, a telescopic pylon or support supporting the turbine and/or the generator, and a base supporting the pylon or support, the method comprising the following operations:

constructing the base;

securing the bottom portion of the pylon or support to the base;

engaging at least a top portion of the pylon or support supporting the turbine and/or generator in said bottom portion so that the pylon or support presents a compact configuration; then:

moving the base and the pylon or support to a site on which the wind generator is to be installed; then:

installing the base in its definitive position; and

deploying the pylon or support using erector means secured to and/or in part incorporated in the pylon or support, in particular means as defined above.

Said composition is preferably selected from the group of compositions comprising: a composition comprising sea water; a composition comprising cement; a composition comprising baryte; and said composition is introduced under pressure into said pylon or support of the wind generator.

The invention makes it possible on the production site (the site where the wind generator is installed) to avoid using large-capacity hoist means.

In a preferred implementation, the base secured to the pylon or support is moved at least in part by sea, by pushing or pulling the base which is immersed, at least in part. For this purpose, is it preferable to use floats secured to the base and/or to the pylon or support, which floats contribute to overall buoyancy and at least some of them are removed from the wind generator once it is in place.

The invention is particularly applicable to constructing wind generators on underwater sites where the depth of the water is not less than 10 m and may be as much as 50 m or 100 m. Under such circumstances in particular, once the base secured to the pylon or support has been moved to a position vertically over the site where the wind generator is to be installed, the buoyancy of the assembly is reduced so as to cause the base to sink progressively together with at least a fraction of the bottom portion of the pylon or support, and the pylon or support is deployed progressively. During these operations, some of said floats are preferably used for reducing buoyancy and making immersion possible. For this purpose, they are separated from the base and/or the pylon or support, or else they are progressively made ineffective by being filled with sea water, for example. Certain other ones of said floats are preferably used for guiding and/or controlling immersion of the structure (base and pylon or support); for this purpose, and where appropriate, it is possible to vary the length of the links connecting them to said structure.

Although the base can be maintained under the water surface but above the water bottom (a “floating” base), the invention is particularly applicable to circumstances in which the base is sunk until it rests on the bottom. In which case, it is preferably filled with a dense material so as to form a gravity base.

### BRIEF DESCRIPTION OF THE DRAWINGS

Other advantages and characteristics of the invention appear from the following description which makes reference to the accompanying drawings and which relates to preferred but non-limiting embodiments of the invention.

FIG. 1 is a side view of a wind generator mounted on a gravity base that is partially filled with ballast, while being towed to its installation site, with the telescopic mast being retracted.

FIGS. 2 and 3 are side view of the FIG. 1 wind generator installed on site, the telescopic pylon being shown respectively retracted and deployed in its final configuration. In FIG. 3, a service vessel is taking off hoisting equipment that is being disassembled.

FIG. 4 is a side view in section showing the use of hoisting drum winches and guide means on the two mutually-displaceable portions of the pylon.

FIG. 5 is a side view in section showing the use of hoist means constituted by linear stepper winches installed on a bottom portion of the pylon, said bottom portion being conical in shape (flaring downwards).

FIG. 6 is a cross-section view on VI-VI of FIG. 5 showing the mutual guide members.

FIG. 7 is a side view in section of sealing devices provided between the cylindrical body of a bottom portion of the pylon and the cylindrical body of a top portion of the pylon which is mounted to slide inside said bottom portion.

FIGS. 8, 9, and 10 show successive steps in partial raising of the top portion of the pylon making use of the buoyancy thrust that applies to a bottom fraction of the top portion of the pylon.

FIG. 11 shows a variant embodiment of the gravity base, having reinforcements for the bottom portion of the pylon.

FIGS. 12 and 13 show a variant embodiment of the gravity base including a temporary additional float element in the form of a cofferdam, respectively during towing and during the final stage of ballasting on site.

### MORE DETAILED DESCRIPTION

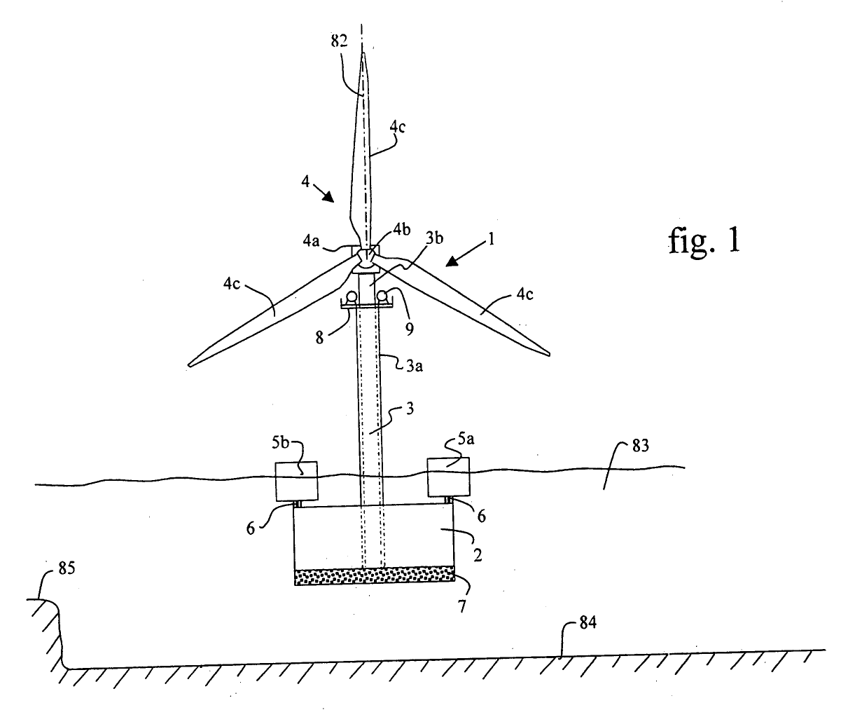

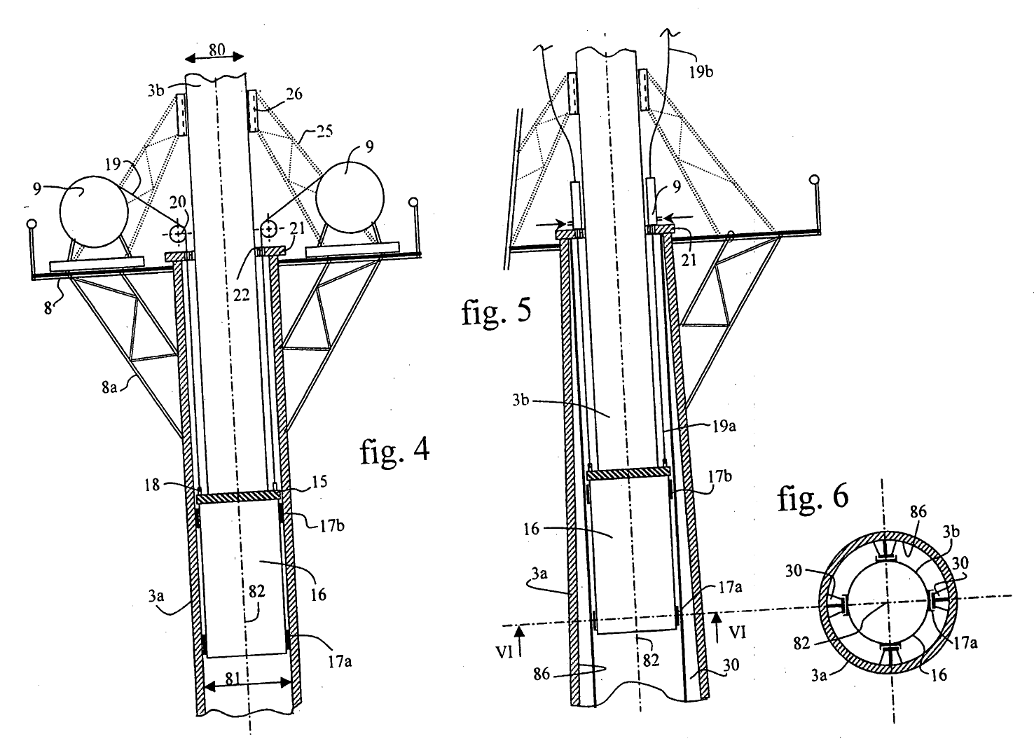

FIGS. 1 to 4 are side views of an off-shore wind generator 1 while it is being put into place, the wind generator comprising a base 2 and a pylon 3 constituted by a bottom portion 3a received in said base, and a top portion 3b of outside diameter 80 smaller than the inside diameter 81 (FIG. 4) of the bottom portion 3a. The two tubular portions 3a and 3b of the pylon can slide along their substantially vertical common longitudinal axis 82 by means of a guide system similar to that shown in FIGS. 5 and 6. The telescopic pylon is shown in its retracted position in FIGS. 1, 2, and 8. At the top of the top portion 3b of the pylon, there is installed the active portion 4 of the wind generator comprising an electricity generator 4a secured to a wind turbine constituted by a shaft 4b that is rotatable about a horizontal axis and that supports three blades 4c.

Stability of the wind generator while it is being towed at sea and put into place on its production site constitutes the most critical point of the entire installation process. In order to ensure that the assembly does not capsize, it is essential according to the rules of the art to keep the position of the buoyancy thrust center above the center of gravity of the entire structure, and to do so by a distance which, according to the so-called “ρ-a” rule, must be greater than 1 m in order to guarantee acceptable stability. Since the ρ-a rule is known to the person skilled in the art of shipbuilding, it is not described in greater detail herein.

Keeping the telescopic pylon 3a, 3b in its retracted position serves to lower the center of gravity of the wind generator since not only is the weight of the top portion of the pylon 3b moved closer to the base 2, but also the head load constituted by the wind generator 4 proper, which weighs about 100 t to 200 t is lowered by the same amount.

Although vertical stability (with a suitable value for ρ-a) can be obtained without having recourse to a telescopic mast, the dimensions of the base would then need to be increased considerably, thereby leading to unacceptably high costs, and considerably increasing the difficulty and the danger of towing the wind generator.

The buoyancy specific to the base and the stability of the assembly as a whole are advantageously increased by additional floats 5a, 5b preferably fixed near the top of the base 2 so as to offset the center of buoyancy thrust upwards, said floats being secured to the base 2 by fasteners 6.

In similar manner, stability is improved by lowering the overall center of gravity by advantageously filling the bottom portion of the base 2 with ballast 7 constituted by heavy aggregate such as iron ore, sand, or any other substance of density considerably greater than that of sea water.

The top 93 of the bottom portion 3a of the pylon is fitted with a working platform 8 having a plurality of winches 9 installed thereon which serve to raise the top portion 3b of the pylon together with the wind generator proper 4.

By way of example, an assembly presenting sufficient stability for towing purposes is constituted by:

a generator turbine weighing 4 t to 100 t;

a top half-pylon 3b having a diameter of 2.6 m, a length of 35 m in the deployed position, and weighing 80 t;

a bottom half-pylon 3a having a diameter of 3.6 m, received in the base and advantageously passing right through it, having a length of 65 m and weighing 150 t,

a concrete base 2 of circular cross-section having a diameter of 22 m and having a height of 14 m, representing a mass of concrete weighing 2650 t, and providing buoyancy of 4600 t;

ballast 7 comprising 1600 t of sand or iron ore; and

four floats 5 each displacing 60 cubic meters (m³)

The resulting ρ-a is 1.1 m, i.e. above the limit, so the assembly is suitable for being towed at sea in order to be installed.

FIGS. 1 to 3 are diagrams showing steps in installing the wind generator and its base 2 at its final location, using the following sequence:

a vessel (not shown) is used to tow the main components of the wind generator from a site 85 where they are prefabricated and assembled in shallow water, to a point vertically over the target point, the pylon being in its retracted position and the base being underwater;

the main base 2 is filled with sea water 83 and the wind generator is stood on the sea bed 84;

the floats 5a and 5b are partially filled with sea water;

the base 2 is filled with ballast, e.g. iron ore or sand taken from near the site; and

the additional floats 5a, 5b are separated from the base 2.

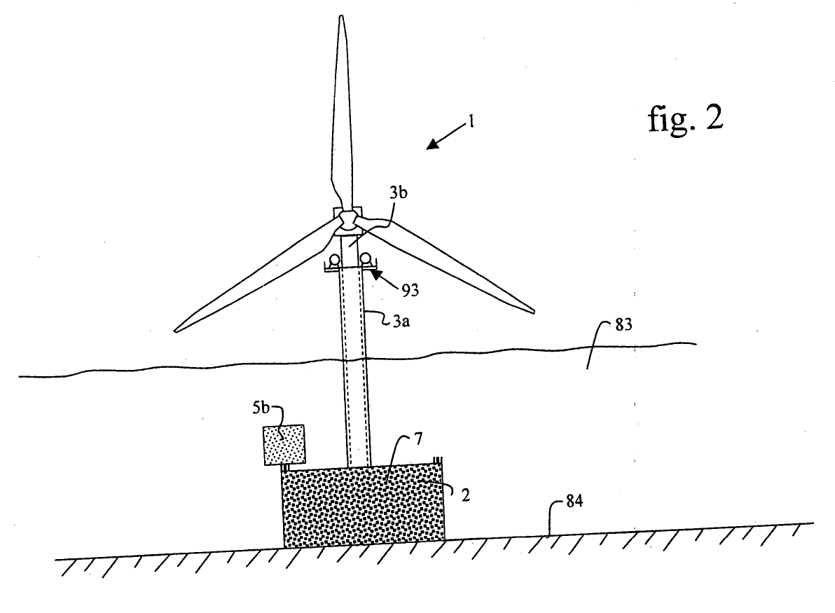

In FIG. 2, the base 2 is shown full of ballast, the float 5b is shown full of water, and the float 5a (not shown), likewise full of sea water, has been detached and recovered for use in installing another wind generator (not shown).

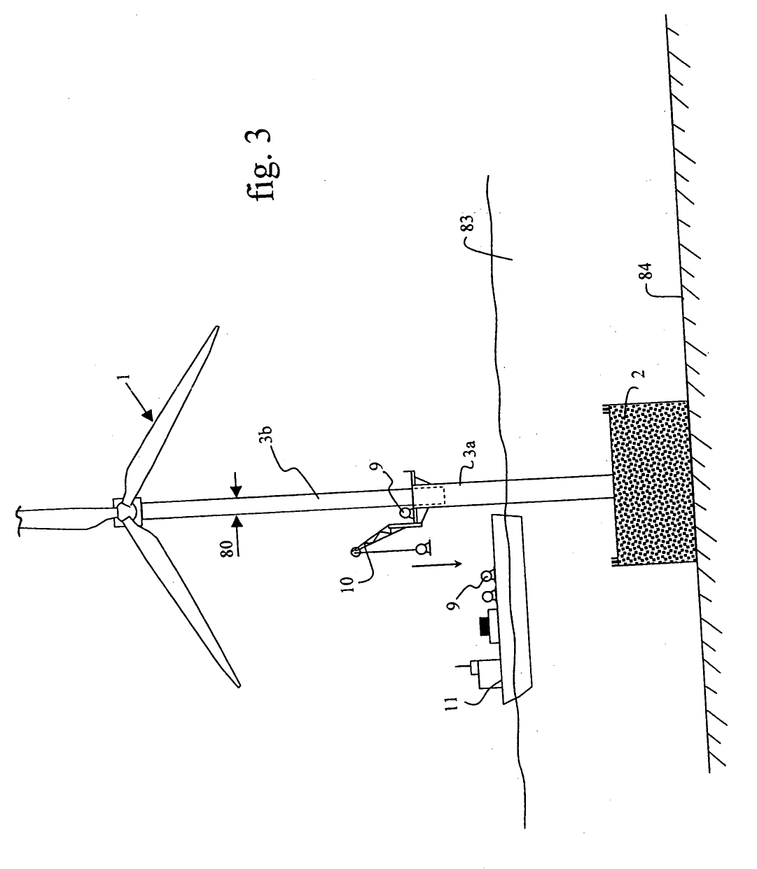

FIG. 3 shows the wind generator installed off-shore in a final configuration after the (top) telescopic portion of the pylon has been deployed by means of the winches 9 working in association with hoisting cables (not shown). The two portions of the pylon have been secured to each other by bolts or by welding so as to establish inter-fitting continuity for the pylon. Once the pylon has been deployed, the hoisting winches 9 can be detached and lowered to a service vessel 11 using shear-legs installed (on land) on the bottom portion of the pylon.

FIGS. 4 to 7 show variant embodiments of the means for deploying the telescopic pylon by buoyancy and/or by cable traction, together with the tubular structures of the pylon portions and their complementary guide means. In FIGS. 4, 5, and 7 there can be seen only a top fraction of a bottom segment of the pylon and a bottom fraction of a top segment of the pylon complementary to said bottom segment.

FIG. 4 is a fragmentary section view of a bottom portion 3a of the pylon associated with a side view of a top portion 3b of the pylon during the procedure of raising the top portion whose own top (not shown) carries the wind turbine and generator. The bottom fraction of the top half-pylon 3b is fitted with a very stiff transverse plate 15 secured to an optionally tubular structure 16 that is likewise very stiff and includes at its periphery, at its top and bottom ends, friction skids 17a-17b for guiding said structure 16 along the inside wall of the bottom half-pylon 3a. The length of said guide structure 16 is preferably greater than 1.5 times the mean diameter of the bottom half-pylon so as to minimize the forces generated on the skids by bending in the pylon. Drum winches 9 are pre-installed on land during manufacture on the platform 8 which is secured to the bottom half-pylon 3a by structural reinforcements 8a. Each of the winches has a cable 19 wound thereon, which cable is guided by a deflector pulley 20 and has its end secured by a link 18 to the plate 15.

A rigid plate 21 forming a flange is welded to the top of the top half-pylon 3b. It has a central bore of diameter greater than the diameter of the top half-pylon, and a series of orifices 22 distributed, optionally uniformly, around its inner periphery. The hoisting cables 19 can thus pass freely through these holes, and when the plates 15 and 22 come into contact at the end of the hoisting of the top portion 3b, they are firmly secured to each other by means of bolts installed through the orifices formed in the upper plate 21 and corresponding orifices (not shown) made during manufacture in the lower plate 15. The fastener members 18 advantageously act as centering pins during the final approach stage of said two flanges by sliding along the axis 82, thereby bringing the respective orifices in the two flanges 15 and 21 into register, thus making it easier to lock the two pylon portions together in position relative to each other.

In order to allow cables to pass between the top and bottom half-pylons and in order to make it possible to put the flange-fixing bolts into place, a radial annular space having a width of about 10 centimeters (cm) to 20 cm is generally required; consequently, with half-pylons 3a and 3b that are circularly cylindrical, the inside diameter of the bottom half-pylon 3a is greater by at least 20 cm to 40 cm than the outside diameter of the top half-pylon 3b.

A complementary guide system is installed above the platform 8 so as to avoid contact between the inner bore of the flange 21 and the outer wall of the pylon 3b during the hoisting stage. The guide system is constituted by a plurality of skids 26 or rollers secured via a very rigid structure 25 to the platform 8 or directly to the half-pylon 3a.

FIGS. 5 and 6 are respectively a side view in section and a cross-section showing a bottom half-pylon 3a that is of conical shape. Guidance for mutual sliding of the portions 3a and 3b of the pylon is then provided by skids 17a-17b secured to the structure 16 and cooperating with rectilinear bars 30 secured to the inside wall 86 of the half-pylon 3a. The bars 30 extend parallel to the axis 82 and thus reconstitute the equivalent of cylindrical guidance. In the section view of FIG. 6, the four skids 17 are shown as being U-shaped so as to prevent the top half-pylon from turning inside the bottom half-pylon, and so as to remain continuously in register with the corresponding bars 30.

Although four bars 30 are shown in FIG. 6, they are advantageously replaced by a single tube of axis coinciding with the axis of the cone and extending from the bottom of the bottom half-pylon to the top plate 21. Said tube is secured to the half-pylon 3a, preferably at regular intervals, so as to impart optimum shape and stiffness to the assembly.

In FIG. 5, hoisting is achieved by means of stepper linear winches 9 constituted by through-axis hydraulic actuators. Such actuators are powered by a hydraulic unit (not shown) at the level of the orifice 31 and they are commonly used in raising engineering works such as the decks of bridges. Since they are known to the person skilled, they are not described in greater detail herein. The cable 19a, 19b passing through the linear winch 9 is tensioned beneath said winch, the top strand 19b being slack and merely connected to the top of the top half-pylon 3b level with the wind generator (not shown). Since such actuators are extremely compact, it is that much easier to remove them after installation has been completed, and also to recover the hoist cables.

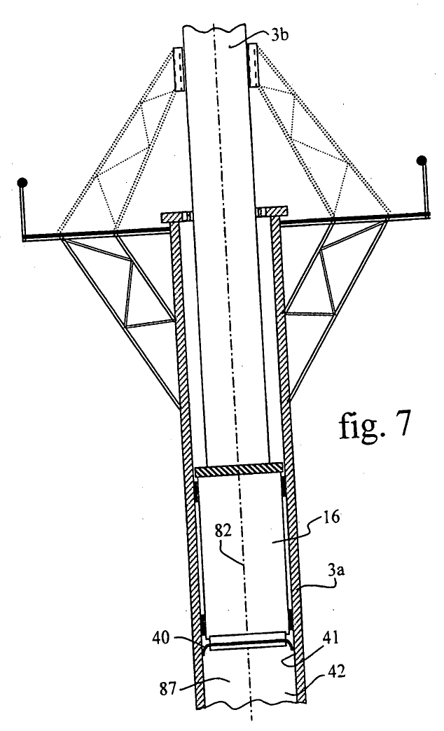

FIG. 7 shows the hoisting operation implemented by using the bottom half-pylon 3a as the actuator cylinder and the rigid guide structure 16 of the top half-pylon 3b as the piston. A wide-lipped gasket 40 provides sealing between the piston 16 and the inside wall 41 of the bottom half-pylon 3a. By pumping sea water from the bottom of the base into the cavity 87 defined by the bottom of the bottom half-pylon 3a (which bottom is made to be entirely leaktight), the assembly comprising the top half-pylon 3a carrying the wind generator at its head is easily raised. The pressure needed for raising purposes is low since the section of the half-pylons is large. The fire hydrant pumps already present on board the service vessel (e.g. 11 in FIG. 3) deliver pressure of 0.8 megapascals (MPa) to 1 MPa, and that suffices to perform the entire operation of raising the top half-pylon. Depending on the delivery rate of the pump, deployment can thus take place in two to three hours.

By way of example, in the configuration of the above-described wind generator, the moving assembly including the top half-pylon requires pressure of 0.25 MPa at the piston in order for it to be raised.

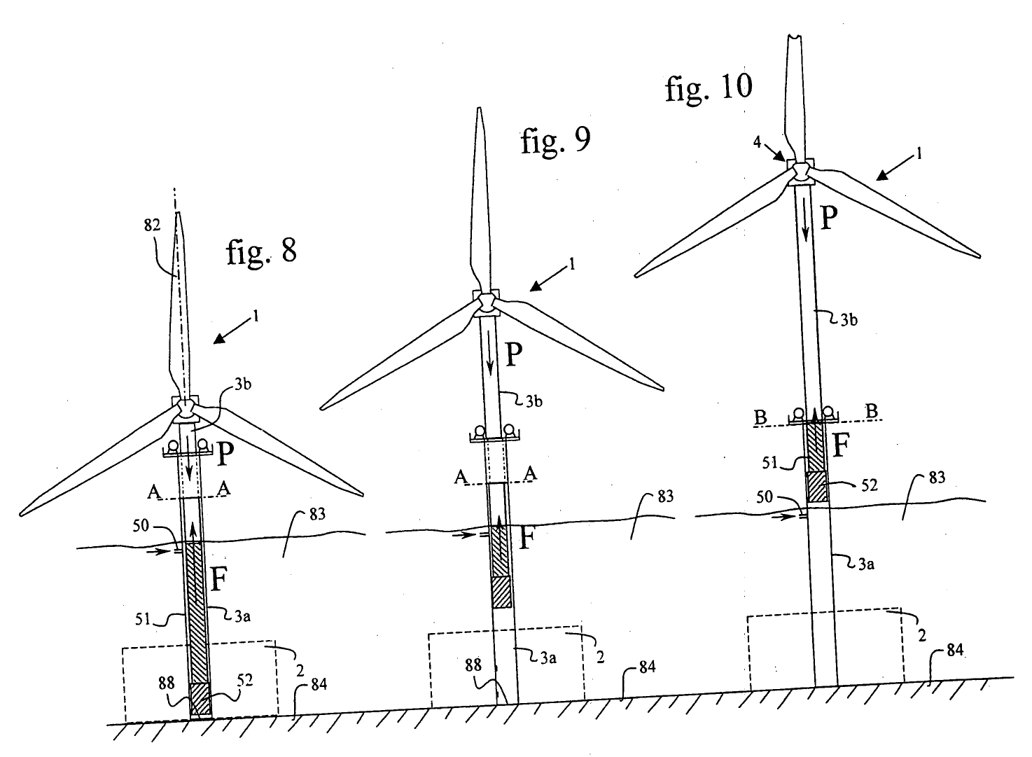

FIGS. 8, 9, and 10 show the use of buoyancy thrust for simplified raising of the superstructure 3b, 4 of the wind generator 1 part of the way.

In these three figures, the wind generator is shown in elevation view above the plane A-A or B-B, while it is shown in section view below said plane.

During transport and installation, the tubular cavity defined by the walls of the bottom half-pylon 3a is empty of water, and the bottom end of the top half-pylon 3b rests on the leaktight bottom 88 of the tubular body of the bottom half-pylon 3a. The top half-pylon is made leaktight so that water does not penetrate into it. Similarly, the guide structure is also made leaktight. No sealing gasket such as the gasket 40 (FIG. 7) is installed at the bottom of said guide structure, and the guide skids 17a-17b allow water to go past. As soon as the cavity defined by the bottom half-pylon (e.g. the cavity 87 shown in FIG. 7) is filled with sea water, the buoyancy thrust applied on the wetted lower fraction of the top half-pylon and the guide structure 16 has the effect of raising the top portion 3b as soon as the upwardly-directed thrust exceeds the weight of the moving assembly, plus the friction forces in the structure.

For this purpose, and as shown in FIG. 8, the sea is put into communication with the inside of the bottom half-pylon 3a via an orifice 50 provided in the wall defining the tubular cavity 87 of the bottom half-pylon 3a by means of a valve (not shown). The shaded portion 51-52 represents the wetted volume that delivers buoyancy thrust, and the resultant force is referenced F.

So long as the force F is greater than the downwardly-directed force P corresponding to the weight of the assembly constituted by the top half-pylon and the wind generator 4, plus friction, said assembly is moved generally upwards until the upwardly-directed force F comes into equilibrium with the downwardly-directed force P, as shown in FIG. 9.

If the bottom half-pylon 3a continues to be filled, e.g. by using one of the fire pumps of the service vessel 11 connected to the orifice 50, so that water rises to the level of the platform 8, i.e. the level of plane BB, then the assembly reaches equilibrium in the position shown in FIG. 10.

Thus, by using buoyancy thrust, a large portion of the raising operation is performed in a manner that is simple and fast. Raising is then terminated over a distance that is very short, for example by means of linear or drum cable winches.

By replacing sea water with a substance of greater density, for example a mud constituted by baryte in suspension in water, it is possible to obtain a liquid of specific gravity that can be as great as 2.5 to 3 relative to sea water, and the height to which hoisting takes place is then increased in substantially the same ratio.

By way of example, using the wind generator configuration described above to explain ρ-a, the moving assembly comprising the top half-pylon 3b and the wind generator 4 can be raised under the effect of buoyancy thrust by 5 m in FIG. 9 and 30 m in FIG. 10.

If the bottom half-pylon is filled with concrete, mortar, or a cement slip, then the ability of the mast to withstand swell is considerably improved once the cement has set.

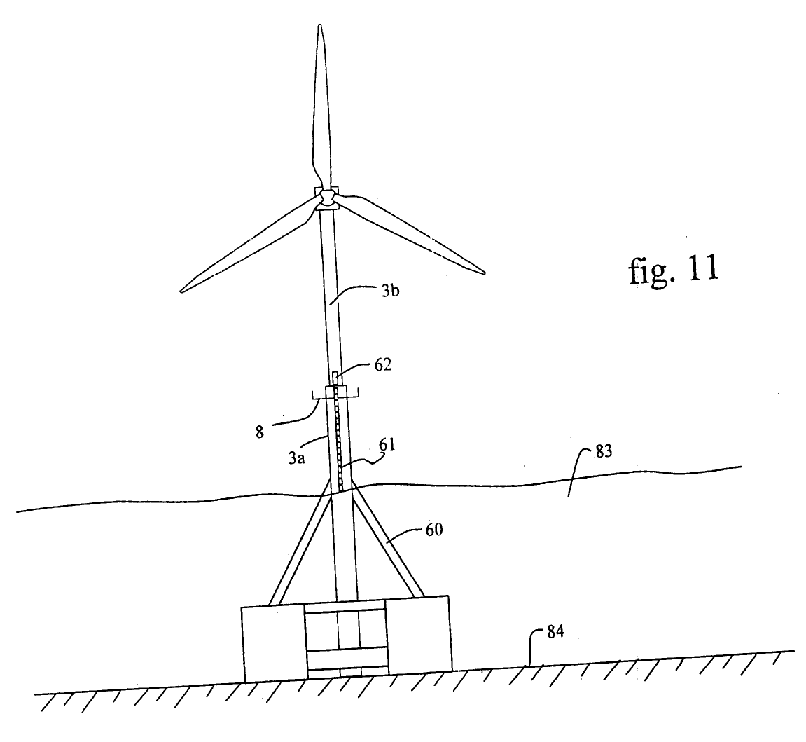

FIG. 11 shows a variant of the gravity base having reinforcements 60 for the bottom portion of the pylon. An access ladder 61 connects the water surface to the assembly platform 8, at which level there is an access door 62. The bottom portion of the pylon can be ballasted with heavy aggregate in order to increase overall stability. Alternatively, when this volume is filled only with sea water, it is possible to add anticorrosion additives so as to avoid any degradation of the structure overtime throughout the lifetime of the wind generator which may reach or exceed 20 years.

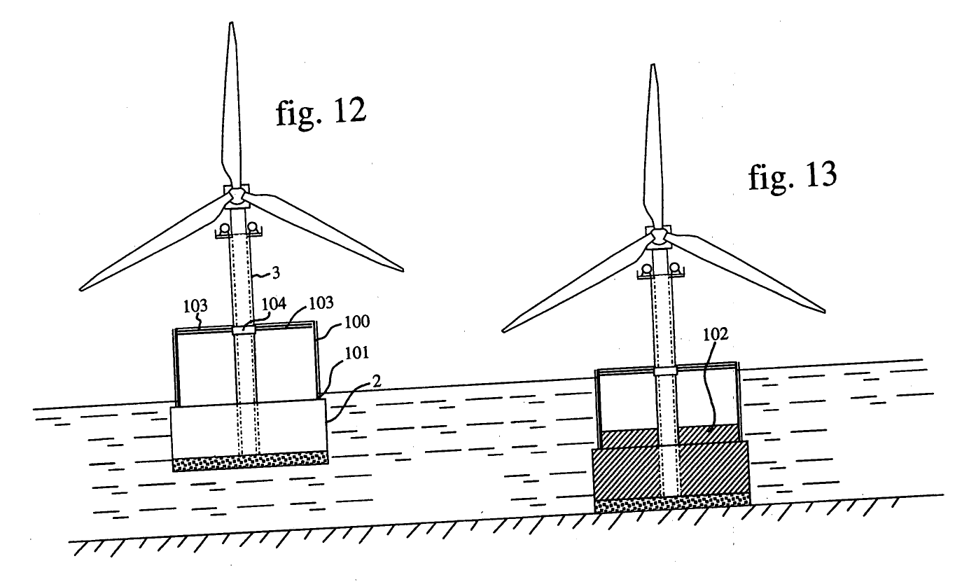

FIG. 12 is an elevation view of a wind generator and a section view of its gravity base provided with a temporary additional float element constituted by a cofferdam 100 pre-installed on the base 2 during manufacture, with the connection between said cofferdam and said base being leaktight at 101. This additional buoyancy provided throughout the towing stage provides additional stability and makes it possible to perform the on-site installation operation of ballasting the base under better conditions of safety.

FIG. 13 shows said base at the end of installation, after the base has been completely ballasted and after said cofferdam 102 has been ballasted in part.

In order to ensure that the cofferdam is stable when subjected to swell and currents during towing and during ballasting, the top portion of the cofferdam is advantageously reinforced by beams 103 connecting the edge of said cofferdam to the shank of the mast 3 in a reinforced zone 104 of said mast. For cofferdams that are tall, it is advantageous to add similar reinforcing beams at intermediate levels, e.g. at 5 m and at 10 m from the base, for a cofferdam presenting a total height of 15 m.

Said cofferdam 100 is advantageously made by assembling together a plurality of circular sectors, e.g. six, eight, or 12 sectors, so as to make it easier to dismantle after the wind generator has been definitively installed. While the cofferdam is being put into place on the base 2, care should be taken to assemble said sectors along their vertical generator lines in such a manner as to ensure they are completely leaktight so as to conserve the increased buoyancy during the towing and installation stages.

The present invention is described above mainly in the context of an off-shore wind generator, but a pylon made in two telescopic segments presents a considerable advantage when installing conventional wind generators on land since the hoisting equipment required can be much less powerful, merely because the maximum working height is divided substantially by two and the heaviest load to be handled is generally the generator proper, together with its hub and blades.

The present invention is described above on the basis of a pylon having two telescopic segments. However, in some circumstances, it is advantageous to consider using three or more segments, said segments telescoping one in another in successive manner.

The present invention is described above on the basis of producing electricity, however it would remain within the spirit of the invention if the energy of the wind were to be converted into any other type of energy, for example by compressing a gas or a fluid in order to export it or transform it on site, or indeed to electrolyze water so as to produce hydrogen and oxygen.

What is claimed is:

1. A wind generator comprising a wind turbine and a deployable pylon or support supporting the turbine, the wind generator including a gravity base supporting the pylon or support.

2. A wind generator according to claim 1, in which the gravity base is hollow, leaktight, and compartmentalized, and is made at least in part out of concrete.

3. A wind generator according to claim 1, in which the base includes means providing a connection with buoyancy means.

4. A wind generator according to claim 3, in which the base includes leaktight connection means connecting it with a cofferdam surmounting the base.

5. A wind generator according to claim 4, in which the cofferdam is connected to the pylon or support by connection means such as beams.

6. A wind generator according to claim 4, in which the cofferdam comprises a plurality of sectors or portions assembled together in leaktight manner.

7. A wind generator according to claim 1, further including means for locking the pylon or support in the deployed position.

8. A wind generator according to claim 1, in which the base is immersed to a depth of not less than 10 m.

9. A wind generator according to claim 1, comprising a wind turbine associated with an electricity generator of power situated in the range 100 kW to 10 MW.

10. A wind generator according to claim 1, comprising a wind turbine having an axis that is substantially horizontal.

11. A wind generator according to claim 1, in which the gravity base contains ballast and rests on the water bottom, and in which the top of the bottom portion of the pylon stands out of the water.

12. A wind generator according to claim 1, in which the deployable pylon or support comprises at least two portions that are movable relative to each other between a compact configuration and a deployed configuration, whereby it is telescopic.

13. A wind generator according to claim 1, in which the pylon or support comprises a bottom portion of elongate shape and a top portion of elongate shape, said bottom and top portions being slidably mounted relative to each other and being engaged at least in part one in the other, the wind generator further including erector means for erecting the pylon or support.

14. A wind generator according to claim 13, in which said erector means comprise means for delivering traction comprising a deformable link such as a cable, means for securing one end of the link to a first of the moving portions of the pylon or support, and means for guiding, supporting, applying traction to and/or winding said link, which means are secured to a second one of said moving portions of the pylon or support.

15. A wind generator according to claim 13, in which said erector means comprise means for delivering hydraulic traction or thrust.

16. A wind generator according to claim 1, in which a bottom portion of the support or pylon comprises a first leaktight tubular body closed by a first leaktight wall within which a bottom fraction of a top portion of the pylon or support can slide.

17. A wind generator according to claim 16, in which said top portion of the pylon or support comprises a second leaktight tubular body closed by a second leaktight wall, and in which said first body is provided with means for introducing a fluid or a slurry into an elongate cavity defined by said first body, and further comprises sealing means suitable for preventing or limiting leakage of a driving fluid introduced into said cavity by passing between said first and second bodies.

18. A method of constructing a wind generator comprising a wind turbine, and preferably a generator, a deployable pylon or support supporting the turbine, and where appropriate the generator, and a base supporting the pylon or support, the method comprising the following operations in succession:
constructing the base;
securing a bottom portion of the pylon or support to the base;
engaging at least a top portion of the pylon or support supporting the turbine and/or the generator in said bottom portion in such a manner that the pylon or support presents a compact configuration; then:
displacing the base and the pylon or support to reach a site at which the wind generator is to be installed; then:
installing the base in its definitive position; and
deploying the pylon or support by using erector means secured to and/or incorporated at least in part in the wind generator, and in particular in the pylon or support.

19. A method according to claim 18, in which the base secured to the pylon or support is displaced at least in part by sea, by pulling or pushing the base which is immersed, at least in part.

20. A method according to claim 19, in which floats or cofferdams are used that are secured to the base and/or to the pylon or support, contributing to the buoyancy of the assembly and separated at least in part from the wind generator, once it is in place.

21. A method according to claim 18, in which, once the base secured to the pylon or support has been brought vertically over the site at which the wind generator is to be implanted, the buoyancy of the assembly is decreased so as to immerse the base and at least a fraction of the bottom portion of the pylon or support, and the pylon or support is deployed by exerting traction and/or thrust between said bottom and top portions of the pylon or support.

22. The use of a fluid or slurry composition for deploying the deployable pylon or support of a wind generator, in particular a wind generator according to claim 1.

23. Use according to claim 22, in which said composition is selected from the group of compositions consisting in:
a composition comprising sea water; a composition comprising cement; a composition comprising baryte; and in which said composition is introduced under pressure into said pylon or support of the wind generator.
